(19) United States
(12) Patent Application Publication
(10) Pub. No.: US 2025/0343318 A1
(43) Pub. Date: Nov. 6, 2025

(54) BATTERY

(71) Applicant: TOYOTA JIDOSHA KABUSHIKI KAISHA, Toyota-shi, (JP)

(72) Inventor: Takuya MATSUYAMA, Miyoshi-shi (JP)

(73) Assignee: TOYOTA JIDOSHA KABUSHIKI KAISHA, Toyota-shi (JP)

(21) Appl. No.: 19/087,121

(22) Filed: Mar. 21, 2025

(30) Foreign Application Priority Data
May 1, 2024 (JP) 2024-074220

(51) Int. Cl. H01M 50/342; H01M 50/121; H01M 50/209; H01M 50/227; H01M 50/293

(52) U.S. Cl. CPC H01M 50/3425; H01M 50/121; H01M 50/209; H01M 50/227; H01M 50/293; H01M 2200/20

(57) ABSTRACT

A battery includes an electrode element, a first exterior body that encloses and seals the electrode element, and a second exterior body that encloses and seals the first exterior body and that has a sealing portion. A part of the sealing portion of the second exterior body has a weak portion having a lower sealing strength than the rest of the sealing portion.

### CROSS-REFERENCE TO RELATED APPLICATION

This application claims priority to Japanese Patent Application No. 2024-074220 filed on May 1, 2024, incorporated herein by reference in its entirety.

### BACKGROUND

### 1. Technical Field

The present disclosure relates to a battery including an electrode element and an exterior body that seals the electrode element.

### 2. Description of Related Art

Japanese Unexamined Patent Application Publication No. 2021-176134 discloses an all-solid-state battery including a battery cell housed inside a laminate film. Japanese Unexamined Patent Application Publication No. 2020-170583 discloses covering an electrode stack with a soft laminate film and a hard laminate film and also discloses an all-solid-state battery.

### SUMMARY

However, when overcharging occurs, high-temperature gas may be released to the outside of the laminate film.

Thus, the present disclosure provides a battery from which high-temperature gas is unlikely to be released to the outside of the battery even when overcharging occurs.

An aspect of the present disclosure provides a battery including an electrode element, a first exterior body, and a second exterior body. The first exterior body encloses and seals the electrode element. The second exterior body encloses and seals the first exterior body, and has a sealing portion. A part of the sealing portion of the second exterior body has a weak portion having a lower sealing strength than the rest of the sealing portion.

In the battery according to the aspect, the first exterior body may be a laminate film.

In the battery according to the aspect, the second exterior body may be a laminate film.

In the battery according to the aspect, the second exterior body may have a rectangular shape in plan view, and the weak portion may be provided in the sealing portion on a short side of the second exterior body.

In the battery according to the aspect, the second exterior body may have a check valve, and a withstand pressure of the check valve from inside to outside of the second exterior body may be higher than a withstand pressure of the weak portion.

In the battery according to the aspect, a pressure between the first exterior body and the second exterior body may be reduced.

In the battery according to the aspect, inert gas may be contained between the first exterior body and the second exterior body.

In the battery according to the aspect, air may be contained between the first exterior body and the second exterior body.

In the battery according to the aspect, the moisture content of the air may be 1000 ppm or less.

In the battery according to the aspect, the electrode element may have a solid electrolyte, and the battery may be a solid-state battery.

With the battery of the present disclosure, gas generated from the electrode element is cooled between the two exterior bodies. Thus, the temperature of gas released to the outside of the second exterior body through the weak portion can be kept low.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is an appearance perspective view of an all-solid-state battery;

FIG. 2 is a plan view of the all-solid-state battery viewed from the direction of arrow II of FIG. 1; and

FIG. 3 is an exploded perspective view of the all-solid-state battery.

### DETAILED DESCRIPTION OF EMBODIMENTS

### 1. Battery

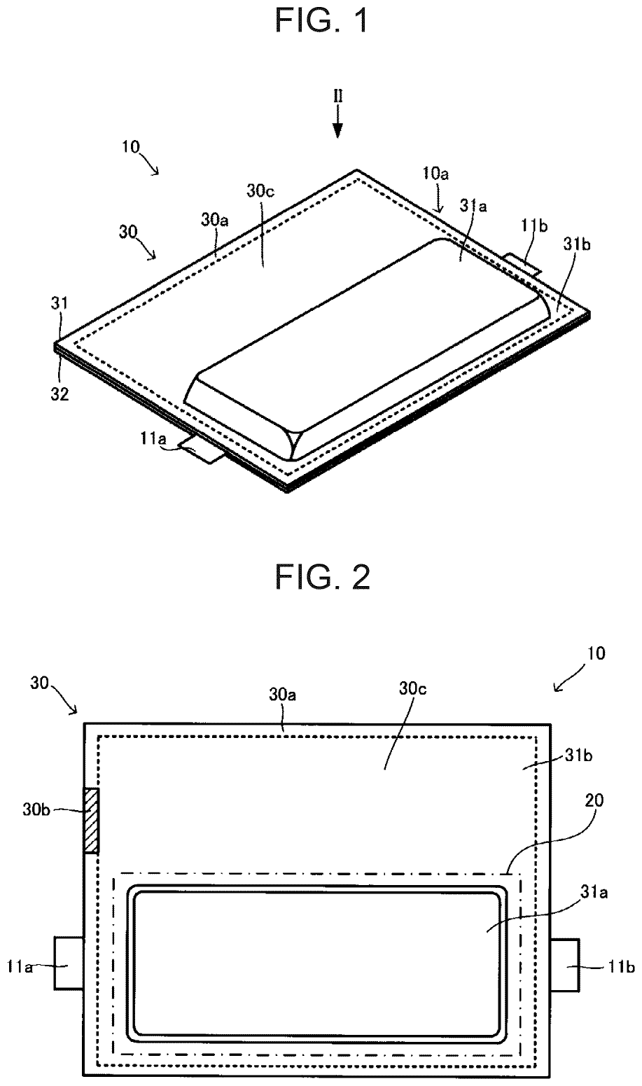

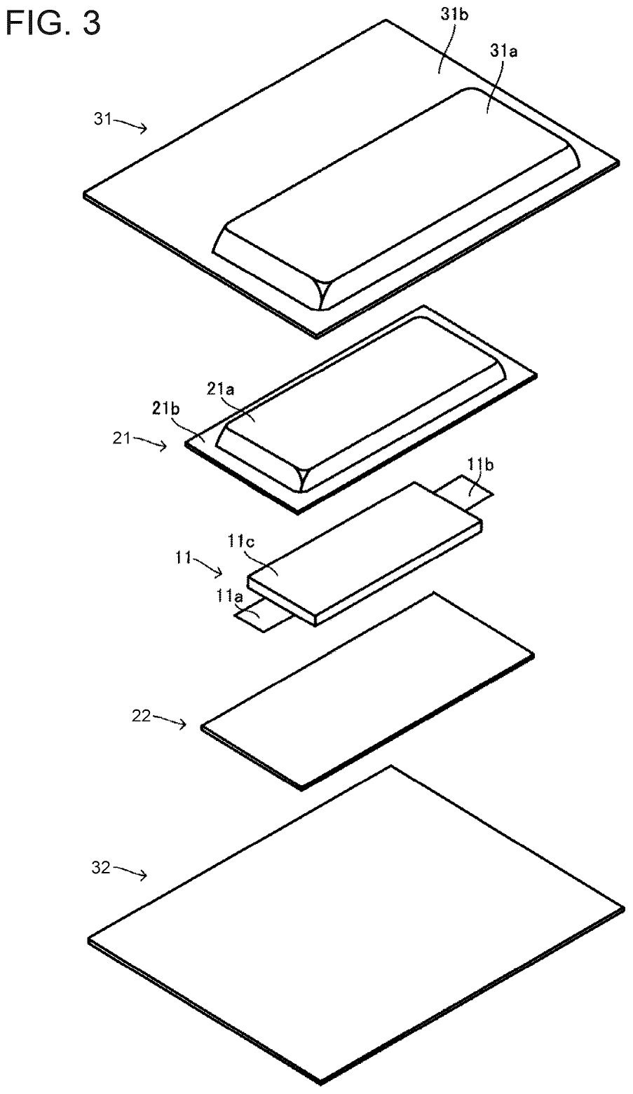

FIGS. 1 to 3 are diagrams for describing a solid-state battery (all-solid-state battery) 10 according to an embodiment. Although the all-solid-state battery will be described here as a typical example, the present disclosure is not necessarily applied to the all-solid-state battery, but is applicable to any battery including an electrode element and an exterior body that seals the electrode element (e.g., a battery containing an electrolytic solution or a solid-state battery (semisolid-state battery) containing a solid electrolyte and an electrolytic solution). FIG. 1 is an appearance perspective view, FIG. 2 is a plan view (diagram viewed in the direction of arrow II of FIG. 1), and FIG. 3 is an exploded perspective view.

As shown in FIGS. 1 to 3, the all-solid-state battery 10 of the present embodiment includes an electrode element 11, a first exterior body 20, and a second exterior body 30. The electrode element 11 having a substantially rectangular shape in plan view is enclosed in the first exterior body 20 having a substantially rectangular shape in plan view, and the first exterior body 20 is further enclosed in the second exterior body 30 having a rectangular shape in plan view. At this time, a positive electrode terminal 11a and a negative electrode terminal 11b extend from the electrode element 11, and a tip of the positive electrode terminal 11a and a tip of the negative electrode terminal 11b project from the first exterior body 20 and the second exterior body 30. Hereinbelow, each configuration and the relationship between the configurations will be described in more detail.

### 1.1. Electrode Element

The electrode element 11 (refer to FIG. 3) has a positive electrode current collector layer, a positive electrode composite layer, a separator layer, a negative electrode composite layer, a negative electrode current collector layer, the positive electrode terminal 11a, and the negative electrode terminal 11b. In the present embodiment, the positive electrode current collector layer, the positive electrode composite layer, the separator layer, the negative electrode composite layer, the negative electrode current collector layer, the negative electrode composite layer, the separator layer, the positive electrode composite layer, and the positive electrode current collector layer are stacked in this order to constitute a unit element, and unit elements are stacked (may be referred to as the “stack 11c”). The positive electrode terminal 11a is electrically connected to the positive electrode current collector layer of the stack 11c, and the negative electrode terminal 11b is electrically connected to the negative electrode current collector layer of the stack 11c. In the present embodiment, the stack 11c also has a rectangular shape in plan view.

### Positive Electrode Current Collector Layer

The positive electrode current collector layer is stacked on the positive electrode composite layer and collects electric current from the positive electrode composite layer. The positive electrode current collector layer has a quadrangular foil shape in plan view. In the present embodiment, the positive electrode current collector layer includes positive electrode current collector foil that is metal foil, and a carbon layer stacked on the positive electrode current collector foil. By the carbon layer being stacked on the positive electrode composite layer, the positive electrode current collector layer is stacked on the positive electrode composite layer. Examples of the material that constitutes the positive electrode current collector foil include stainless steel, aluminum, nickel, iron, and titanium. The carbon layer is made of a carbon-containing material.

### Positive Electrode Composite Layer

The positive electrode composite layer has one surface on which the positive electrode current collector layer is stacked and the other surface on which the separator layer is stacked. The positive electrode composite layer has a quadrangular sheet shape in plan view.

The positive electrode composite layer is a layer containing a positive electrode active material, and may further contain at least one of a solid electrolyte material, a conductive material, and a binding material as needed. A known active material may be used as the positive electrode active material. Examples of the positive electrode active material include cobalt-based materials (e.g., LiCoO₂), nickel-based materials (e.g., LiNiO₂), manganese-based materials (e.g., LiMn₂O₄ and Li₂Mn₂O₃), iron phosphate-based materials (e.g., LiFePO₄ and Li₂FeP₂O₇), NCA-based materials (compounds of nickel, cobalt, and aluminum), and NMC-based materials (compounds of nickel, manganese, and cobalt).

More specifically, LiNi_{1/3}Co_{1/3}Mn_{1/3}O₂ is an example of the positive electrode active material. The surface of the positive electrode active material may be coated with an oxide layer, such as a lithium niobate layer, a lithium titanate layer, or a lithium phosphate layer.

The solid electrolyte is preferably an inorganic solid electrolyte. This is because an inorganic solid electrolyte has a higher ion conductivity and better heat resistance than an organic polymer electrolyte. Examples of the inorganic solid electrolyte include a sulfide solid electrolyte and an oxide solid electrolyte. Examples of the sulfide solid electrolyte material having Li-ion conductivity include Li₂S—P₂S₅, Li₂S—P₂S₅—LiI, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅-ZmSn (where, m and n are positive numbers, and Z is Ge, Zn, or Ga), Li₂S—GeS₂, Li₂S—SiS₂—Li₃PO₄, Li₂S—SiS₂-LiₓMO_{y} (where, x and y are positive numbers, and M is P, Si, Ge, B, Al, Ga, or In). Note that the above description “Li₂S—P₂S₅” means a sulfide solid electrolyte material made of a raw material composition containing Li₂S and P₂S₅, and the same applies to other descriptions.

On the other hand, the oxide solid electrolyte material having Li-ion conductivity is, for example, a compound having a NASICON-type structure. Examples of the compound having a NASICON-type structure include a compound (LAGP) represented by a general formula Li₁₊ₓAlₓGe₂₋ₓ(PO₄)₃ (0≤x≤2), and a compound (LATP) represented by a general formula Li₁₊ₓAlₓTi₂₋ₓ(PO₄)₃ (0≤x≤2). In addition, other examples of the oxide solid electrolyte material include LiLaTiO (e.g., Li_{0.34}La_{0.51}TiO₃), LiPON (e.g., Li_{2.9}PO_{3.3}N_{0.46}), and LiLaZrO (e.g., Li₇La₃Zr₂O₁₂).

Although the binding material is not limited to any particular material as long as the biding material is chemically and electrically stable, examples of the binding material include fluorine-based binding materials, such as polyvinylidene fluoride (PVDF) and polytetrafluoroethylene (PTFE), rubber-based binding materials, such as styrene-butadiene rubber (SBR), olefin-based binding materials, such as polypropylene (PP) and polyethylene (PE), and cellulose-based binding materials, such as carboxymethyl cellulose (CMC). Examples of the conductive material include carbon materials, such as acetylene black (AB), Ketjen black, and carbon fiber, and metallic materials, such as nickel, aluminum, and stainless steel.

The content of each component in the positive electrode composite layer may be the same as a conventional content. In addition, the thickness of the positive electrode composite layer is, for example, preferably 0.1 μm or more and 1 mm or less, and more preferably 1 μm or more and 150 μm or less.

### Separator Layer

The separator layer (solid electrolyte layer) is a layer that has a quadrangular sheet shape in plan view, is disposed between the positive electrode composite layer and the negative electrode composite layer, and contains a solid electrolyte material. The separator layer contains at least the solid electrolyte material. The solid electrolyte material may be the same as the solid electrolyte material described for the positive electrode composite layer.

### Negative Electrode Composite Layer

The negative electrode composite layer is a layer containing at least a negative electrode active material. The negative electrode composite layer may contain a binding material, a conductive material, and a solid electrolyte material as needed. The binding material, the conductive material, and the solid electrolyte material may be the same as those of the positive electrode composite layer.

Although the negative electrode active material is not limited to any particular material, examples of the negative electrode active material in the case of a lithium ion battery include carbon materials, such as graphite and hard carbon, various oxides, such as lithium titanate, Si and Si alloys, metallic lithium, and lithium alloys.

The negative electrode composite layer has a quadrangular sheet shape in plan view. The negative electrode composite layer has one surface on which the separator layer is stacked and the other surface on which the negative electrode current collector layer is stacked. The content of each component in the negative electrode composite layer may be the same as a conventional content. In addition, the thickness of the negative electrode composite layer is, for example, preferably 0.1 μm or more and 1 mm or less, and more preferably 1 μm or more and 150 μm or less.

### Negative Electrode Current Collector Layer

The negative electrode current collector layer is stacked on the negative electrode composite layer and collects electric current from the negative electrode composite layer. The negative electrode current collector layer has a quadrangular foil shape in plan view and can be made of, for example, stainless steel, copper, nickel, or carbon.

### Positive Electrode Terminal and Negative Electrode Terminal

The positive electrode terminal 11a and the negative electrode terminal 11b are members having electrical conductivity, and each of the positive electrode terminal 11a and the negative electrode terminal 11b serves as the terminal for electrically connecting the corresponding electrode to the outside. The positive electrode terminal 11a has one end that is electrically connected to the positive electrode current collector layer, and the other end that penetrates a sealing portion of the first exterior body 20 and a sealing portion 30a of the second exterior body 30 and is exposed to the outside. The negative electrode terminal 11b has one end that is electrically connected to the negative electrode current collector layer, and the other end that penetrates the sealing portion of the first exterior body 20 and the sealing portion 30a of the second exterior body 30 and is exposed to the outside.

### 1.2. First Exterior Body

As indicated by a dot-dash line in FIG. 2 and shown in an exploded perspective view of FIG. 3, the first exterior body 20 in the present embodiment is a member having a rectangular sheet shape in plan view, and includes a first sheet 21 and a second sheet 22 (refer to FIG. 3). The stack 11c of the electrode element 11 is enclosed between the first sheet 21 and the second sheet 22, and an outer peripheral end portion of the first sheet 21 and an outer peripheral end portion of the second sheet 22 are joined together to constitute the sealing portion. Thus, the first exterior body 20 has a bag shape, and encloses and seals the electrode element 11 inside thereof.

The first sheet 21 has a quadrangular shape in plan view, and has a recess 21a having a quadrangular shape in plan view (an opening of the recess 21a is located on the lower side of the paper in the viewpoint of FIG. 3 and thus hidden from view due to a blind spot). The stack 11c of the electrode element 11 is housed inside the recess 21a. An outer peripheral edge of the recess 21a is provided with an overhang 21b projecting from the edge, and the overhang 21b and the outer peripheral end portion of the surface of the second sheet 22 are joined together to constitute the sealing portion.

The second sheet 22 has a flat and quadrangular sheet shape in plan view. As described above, on the face of the second sheet 22 facing the overhang 21b of the first sheet 21, the outer peripheral end portion of the second sheet 22 is overlaid on and joined to the overhang 21b of the first sheet 21 to constitute the sealing portion.

The first sheet 21 and the second sheet 22 in the present embodiment are laminate films. The laminate film is a film having a metal layer and a sealant material layer. Examples of metal used in the laminate film include aluminum, and stainless steel. Examples of the material used in the sealant material layer include polypropylene, polyethylene, polystyrene, and polyvinyl chloride, which are thermoplastic resins. A method of forming the sealing portion between the first sheet 21 and the second sheet 22, that is, a method of joining the laminate films together is not limited to any particular method, and a known method can be used. Specifically, examples of the method include a method of welding the sealant material layers of the laminate films together (e.g., hot plate welding, ultrasonic welding, vibration welding, or laser welding) and bonding with an adhesive.

Although the first exterior body 20 includes the first sheet 21 and the second sheet 22 that are separate sheets, this is not a limitation. The electrode element 11 may be wrapped with one sheet, and end portions of the sheet overlapping in a wrapping state may be joined together. Although, in the embodiment described above, only the first sheet 21 is provided with the recess 21a and the second sheet 22 is flat, this is not a limitation. Each of the first sheet and the second sheet may be provided with a recess, and the stack of the electrode element may be disposed in the recesses.

### 1.3. Second Exterior Body

As shown in FIGS. 1 to 3, the second exterior body 30 in the present embodiment is a member having a rectangular sheet shape in plan view, and includes a first sheet 31 and a second sheet 32. The first exterior body 20 (enclosing the stack 11c of the electrode element 11 inside) is enclosed between the first sheet 31 and the second sheet 32, and an outer peripheral end portion of the first sheet 31 and an outer peripheral end portion of the second sheet 32 are joined together to constitute the sealing portion 30a (an area outside a dashed line in FIGS. 1 and 2). Thus, the second exterior body 30 has a bag shape, and encloses and seals the electrode element 11 and the first exterior body 20 inside thereof.

### First Sheet, Second Sheet, and Sealing Portion

The first sheet 31 has a quadrangular shape in plan view, and has a recess 31a having a quadrangular shape in plan view (an opening of the recess 31a is located on the lower side of the paper in the viewpoint of FIG. 3 and thus hidden from view due to a blind spot). The recess 21a of the first exterior body 20 and the stack 11c of the electrode element 11 enclosed in the recess 21a are housed inside the recess 31a. An outer peripheral edge of the recess 31a is provided with an overhang 31b projecting from the edge, and a part of the overhang 31b and the outer peripheral end portion of the surface of the second sheet 32 are joined together to constitute the sealing portion 30a.

The second sheet 32 has a flat and rectangular sheet shape in plan view. As described above, on the face of the second sheet 32 facing the overhang 31b of the first sheet 31, the outer peripheral end portion of the second sheet 32 is overlaid on and joined to the overhang 31b of the first sheet 31 to constitute the sealing portion 30a.

The first sheet 31 and the second sheet 32 in the present embodiment are laminate films. The laminate film is a film having a metal layer and a sealant material layer. Examples of metal used in the laminate film include aluminum, and stainless steel. Examples of the material used in the sealant material layer include polypropylene, polyethylene, polystyrene, and polyvinyl chloride, which are thermoplastic resins. A method of forming the sealing portion 30a between the first sheet 31 and the second sheet 32, that is, a method of joining the laminate films together is not limited to any particular method, and a known method can be used. Specifically, examples of the method include a method of welding the sealant material layers of the laminate films together (e.g., hot plate welding, ultrasonic welding, vibration welding, or laser welding) and bonding with an adhesive.

Although the second exterior body 30 includes the first sheet 31 and the second sheet 32 that are separate sheets, this is not a limitation. The first exterior body 20 that seals the electrode element 11 may be wrapped with one sheet, and end portions of the sheet overlapping in a wrapping state may be joined together. Although, in the embodiment described above, only the first sheet 31 is provided with the recess 31a and the second sheet 32 is flat, this is not a limitation. Each of the first sheet and the second sheet may be provided with a recess, and the stack of the electrode element may be disposed in the recesses.

### Weak Portion

As shown by hatching in FIG. 2, the sealing portion 30a has a weak portion 30b. The weak portion 30b belongs to the sealing portion 30a and is the part where the first sheet 31 and the second sheet 32 are joined together as described above. The weak portion 30b is configured to have a lower joining strength (sealing strength) than the rest of the sealing portion 30a. Accordingly, when the sealing of the sealing portion 30a is broken, the weak portion 30b is configured such that the sealing in the weak portion 30b is preferentially broken. Thus, it is only required that the weak portion 30b be configured such that the sealing in the weak portion 30b is preferentially broken, and the degree of the low joining strength is not limited to any particular degree. The range of the weak portion 30b is not limited to any particular range, and it is only required that a part of the sealing portion 30a serve as the weak portion 30b. However, the weak portion 30b is preferably provided in the sealing portion 30a on a short side of the second exterior body 30 having a rectangular shape in plan view. The weak portion 30b can be formed by making the joining conditions different between the weak portion 30b and the sealing portion 30a other than the weak portion 30b. For example, a temperature condition, a pressing condition, and the time for welding are changed in the method of welding described above. Although the ratio of the weak portion 30b to the sealing portion 30a is not limited to any particular ratio, the length of the weak portion 30b is preferably 5% or more and 80% or less of the total length (the length in the peripheral direction) of the sealing portion 30a, more preferably 10% or more, and even more preferably 20% or more. Furthermore, the length is more preferably 60% or less, and even more preferably 50% or less.

### Unjoined Portion

In addition, the second exterior body 30 has in its inside an unjoined portion 30c where the first sheet 31 and the second sheet 32 are not joined. The unjoined portion 30c is provided inside the sealing portion 30a (inside a dotted line in FIG. 2) and outside the first exterior body 20. Although the unjoined portion 30c is sandwiched between the first sheet 31 and the second sheet 32, the first sheet 31 and the second sheet 32 are not joined to each other in the unjoined portion 30c. Thus, when fluid flows into the unjoined portion 30c, the unjoined portion 30c expands. The unjoined portion 30c may contain gas. In this case, although the contained gas is not limited to any particular type of gas, inert gas or air is preferably contained. In the case of air, the moisture content of the air is preferably low, for example, 1000 ppm or less, and more preferably 375 ppm or less. On the other hand, the unjoined portion 30c may be brought into a depressurized state. This enables the unjoined portion 30c to receive more gas leaking from the first exterior body 20. In this case, in appearance, the first sheet 31 and the second sheet 32 are disposed in contact with and overlapping each other (but not joined).

The size of the unjoined portion 30c is not limited to any particular size, and it is only required that the unjoined portion 30c be provided. However, by increasing the size of the unjoined portion 30c, the amount of gas that can be stored in the unjoined portion 30c increases, and an effect described further below increases. However, the size of the unjoined portion 30c does not have to be too large. Specifically, in plan view of the battery 10 as in FIG. 2, the area occupied by the unjoined portion 30c (may be referred to as the “unjoined portion ratio”) in the range (area) surrounded by the sealing portion 30a is preferably 5% or more, more preferably 10% or more, and even more preferably 30% or more.

### 2. Manufacture

### 2.1. First Aspect

The all-solid-state battery 10 can be produced, for example, in the following manner as a first aspect. The stack 11c of the electrode element 11 is housed in the recess 21a previously formed in the first sheet 21 that is to be a part of the first exterior body 20. Then, the first sheet 21 and the second sheet 22 are overlaid one on top of the other, and the overhang 21b of the first sheet 21 and the end portion of the surface of the second sheet 22 are joined together to form the sealing portion. At this time, evacuation may be performed to degas the inside of the recess 21a. Next, the first exterior body 20 enclosing the electrode element 11 is housed in the recess 31a previously formed in the first sheet 31 that is to be a part of the second exterior body 30. Then, the first sheet 31 and the second sheet 32 are overlaid one on top of the other, and the overhang 31b of the first sheet 31 and the end portion of the surface of the second sheet 32 are joined together to form the sealing portion 30a. At this time, evacuation is performed to degas the inside of the unjoined portion 30c. The evacuation is preferably performed in a vacuum atmosphere, an inert gas atmosphere, or an atmosphere of air with an adjusted moisture content.

### 2.2. Second Aspect

The all-solid-state battery 10 can also be produced, for example, in the following manner as a second aspect. The electrode element is wrapped with one sheet such that the stack 11c of the electrode element 11 is sandwiched between overlapping parts of the sheet. End portions of the sheet that face each other due to the sheet wrapping the electrode element 11 are overlaid one on top of the other and joined together to form the sealing portion of the first exterior body. At this time, by evacuating the inside of the sheet, the sheet is deformed along the shape of the electrode element 11 to form a recess, and the sheet becomes the first exterior body. The first exterior body enclosing the electrode element is wrapped with one sheet such that the first exterior body is sandwiched between overlapping parts of the sheet. End portions of the sheet that face each other due to the sheet wrapping the first exterior body are overlaid one on top of the other and joined together to form the sealing portion of the second exterior body. At this time, by evacuating the inside of the sheet, the sheet is deformed along the shape of the first exterior body to form a recess, and the sheet becomes the second exterior body. The evacuation is preferably performed in a vacuum atmosphere, an inert gas atmosphere, or an atmosphere of air with an adjusted moisture content.

### 3. Effects

With the battery of the present disclosure, even if gas is generated from the electrode element under abnormal conditions and released by breaking the sealing portion of the first exterior body 20, the gas reaches the unjoined portion 30c of the second exterior body 30 and is held in the unjoined portion 30c for a certain period of time. This lowers the temperature of the released gas. Furthermore, even if the sealing portion 30a of the second exterior body 30 is broken and the gas is released to the outside, since the temperature of the gas is lowered, it is possible to restrain the reaction of the gas with oxygen in the atmosphere and restrain the occurrence of problems caused by high-temperature gas. This also makes it possible to eliminate or reduce the application of a heat insulator that is required as a countermeasure against release of high-temperature gas. Since the sealing portion 30a has the weak portion 30b, when the sealing of the sealing portion 30a is broken, the weak portion 30b is preferentially broken. Thus, the direction in which the gas flows out can be controlled, and the influence of the gas can be reduced. In addition, by partially providing the weak portion, the area of the portion to be broken can be reduced. Thus, gas flow from the inside to the outside becomes dominant, and the inflow of gas (oxygen) from the outside to the inside is reduced, thereby making it possible to restrain the occurrence of reactions.

### 4. Modification

In the battery of the present disclosure, the second exterior body may be provided with a check valve to control the flow of gas from the inside to the outside of the battery. However, in this case, the withstand pressure from the inside to the outside of the check valve is preferably higher than the withstand pressure of the weak portion. Accordingly, the effects described above effectively act.

### 5. Example

### 5.1. Test Body (Battery)

In an example, a test in which gas is intentionally released by applying a severe load (overcharge) to a battery under different conditions of battery configuration was conducted. An electrode element containing a sulfide solid electrolyte was produced, and the electrode element was wrapped with one laminate film such that a stack of the electrode element was sandwiched between overlapping parts of the laminate film. Next, a space between the electrode element and the laminate film was evacuated to reduce pressure, and overlapping end portions of the laminate film that face each other due to the laminate film wrapping the electrode element were partially joined together and sealed. The joining at this time was performed by hot plate welding, at a temperature of 200° C., a pressing force of 0.25 MPa, and a time of 30 seconds. In this manner, a first exterior body enclosing the electrode element was obtained. Next, the first exterior body enclosing the electrode element was wrapped with one laminate film such that the first exterior body was sandwiched between overlapping parts of the laminate film. Next, a space between the first exterior body and the laminate film was evacuated to reduce pressure, and overlapping end portions of the laminate film that face each other due to the laminate film wrapping the first exterior body were partially joined together to form a sealing portion. The joining at this time was performed by hot plate welding, at a temperature of 200° C., a pressing force of 0.20 MPa, and a time of 30 seconds in a weak portion of the sealing portion. The rest of the sealing portion was sealed at a temperature of 200° C., a pressing force of 0.25 MPa, and a time of 30 seconds. In this manner, a second exterior body was formed, and a battery having a rectangular shape (300 mm in the long side and 90 mm in the short side) in plan view was obtained. In addition, the unjoined portion ratio was 50%.

Different conditions for each example are shown in Table 1. In Table 1, “sealing atmosphere” is the atmosphere in which the second exterior body was sealed. That is, “vacuum” means that the sealing was performed in a vacuum atmosphere, “argon” means that the sealing was performed in an argon atmosphere, which is an inert gas, and “air” means that the sealing was performed in an air atmosphere (a dew point environment is shown in ° C. and the moisture content is shown in ppm).

### 5.2. Test

The battery in each example was continuously charged at a rate of 5.5 C, and the test was performed until the sealing portion of the second exterior body was broken. The results are shown together with the time to ignition when ignition occurred, and “Not occurred” is shown when no ignition occurred. Here, “ignition” is a result set under intentionally excessive test conditions that are not assumed under normal use conditions in order to clearly distinguish the effects, and is only for testing purposes. This sort of thing is not assumed to occur under normal battery use conditions, even if an anomaly occurred. Since the ignition in this test is caused by the released gas having high temperature, the absence of ignition means that the temperature of the gas is low, and a case in which it takes time to ignite means that the temperature of the gas is lower than that in a case in which ignition immediately occurs. Table 1 shows the results.

### 5.3. Results

The results are shown in Table 1 together with the conditions. In Table 1, “position of weak portion” means a part joined under weak portion joining conditions when the sealing portion of the second exterior body is formed. “All sides” means that all sides of the sealing portion of the second exterior body are joined under the weak portion joining conditions. “Long side” means that the long side portion of the rectangle in plan view is joined under the weak portion joining conditions, and “short side” means that the short side portion of the rectangle in plan view is joined under the weak portion joining conditions.

TABLE 1

| | | | Result | |
|---|---|---|---|---|
| | | Position of | | Time |
| No. | Sealing atmosphere | weak portion | Ignition | (second) |
| 1 | Vacuum | All sides | Occurred | 0 |
| 2 | Vacuum | Long side | Occurred | 3 |
| 3 | Vacuum | Short side | Not occurred | — |
| 4 | Argon | Short side | Not occurred | — |
| 5 | Air (25° C., 31000 | Short side | Occurred | 1 |
| | ppm) | | | |
| 6 | Air (0° C., 6032 ppm) | Short side | Occurred | 6 |
| 7 | Air (−30° C., 375 ppm) | Short side | Not occurred | — |
| 8 | Air (−70° C., 2.58 ppm) | Short side | Not occurred | — |

As can be seen from Table 1, when the second exterior body is provided, the temperature of gas released from the second exterior body can be lowered by providing the weak portion on any of the sides of the rectangle in plan view. When the atmosphere for sealing is an air atmosphere (air is contained in the unjoined portion), the moisture content is preferably low.

The effect becomes particularly remarkable when the weak portion is provided on the short side in plan view. In the example of No. 2 (the sealing was performed in a vacuum atmosphere, and the weak portion was provided on the long side), a certain effect was observed because it was possible to delay ignition, but ignition did occur. This may be because of the following reason. Since the area of the portion to be opened (where the sealing is to be broken) is large due to the weak portion formed on the long side, inside and outside the second exterior body, the gas pressure from the outside to the inside becomes larger than the gas pressure from the inside to the outside, which allows gas to easily enter the inside from the outside and accelerates the reaction with air (oxygen) flowed in. This becomes most obvious in the example of No. 1 in which all the sides are to be opened. Since the area of the portion to be opened (where the sealing is to be broken) is the largest, inside and outside of the second exterior body, the gas pressure from the outside to the inside becomes larger than the gas pressure from the inside to the outside, which allows gas to easily enter the inside from the outside. On the other hand, when the weak portion is provided on the short side, since the area of the portion to be opened (where the sealing is to be broken) is smaller than that in the other examples, inside and outside of the second exterior body, the gas pressure from the inside to the outside is likely to become larger than the gas pressure from the outside to the inside, which maintains a state in which gas is unlikely to enter the inside from the outside. Thus, it can be considered that ignition is unlikely to occur or no ignition occurs.

What is claimed is:

1. A battery comprising:
an electrode element;
a first exterior body that encloses and seals the electrode element; and
a second exterior body that encloses and seals the first exterior body, the second exterior body having a sealing portion, wherein
a part of the sealing portion of the second exterior body has a weak portion having a lower sealing strength than the rest of the sealing portion.

2. The battery according to claim 1, wherein the first exterior body is a laminate film.

3. The battery according to claim 1, wherein the second exterior body is a laminate film.

4. The battery according to claim 1, wherein:
the second exterior body has a rectangular shape in plan view; and
the weak portion is provided in the sealing portion on a short side of the second exterior body.

5. The battery according to claim 1, wherein:
the second exterior body has a check valve; and
a withstand pressure of the check valve from inside to outside of the second exterior body is higher than a withstand pressure of the weak portion.

6. The battery according to claim 1, wherein a pressure between the first exterior body and the second exterior body is reduced.

7. The battery according to claim 1, wherein inert gas is contained between the first exterior body and the second exterior body.

8. The battery according to claim 1, wherein air is contained between the first exterior body and the second exterior body.

9. The battery according to claim 8, wherein a moisture content of the air is 1000 ppm or less.

10. The battery according to claim 1, wherein:
the electrode element has a solid electrolyte; and
the battery is a solid-state battery.
